(19) United States
(12) Patent Application Publication
(10) Pub. No.: US 2004/0131750 A1
(43) Pub. Date: Jul. 8, 2004

(54) Foodstuff

(76) Inventors: David Paul Russell, Melton Mowbray (GB); Bortho Stein Von Kamienski, Verden-Walle (DE); Eike Lange, Kirchlinteln (DE); Tasuja Sirel, Kirchlinteln (DE)

Correspondence Address: FULBRIGHT & JAWORSKI, LLP, 1301 MCKINNEY, SUITE 5100, HOUSTON, TX, 77010-3095, US

(21) Appl. No.: 10/467,923

(22) PCT Filed: Feb. 18, 2002
(86) PCT No.: PCT/GB02/00685

(30) Foreign Application Priority Data
Feb. 16, 2001 (GB) 0103879.3

(51) Int. Cl. A23L 1/325

(52) U.S. Cl. 426/643

(57) ABSTRACT

A method of providing a concentrated animal protein product for use as a protein source in foodstuffs comprises hydrolysing the animal protein to form a slurry and removing water from the slurry and optionally removing fat from the concentrated animal protein product prior to inclusion of the product in a foodstuff. The hydrolysis can be enzymatic hydrolysis or autolysis.

### CROSS-REFERENCE TO RELATED APPLICATIONS

This application is a national stage filing of PCT/GB02/00685 filed Feb. 18, 2002 claiming priority to GB 0103879.3 filed Feb. 16, 2001.

### TECHNICAL FIELD

This invention relates to a concentrated animal protein, such as meat protein, product suitable for use as a protein source in foodstuffs, such as pet foods.

### BACKGROUND OF THE INVENTION

It is nutritionally desirable in the manufacture of processed foodstuffs, including pet foods, to incorporate protein into the food product. It is known to incorporate protein into foodstuffs from a number of sources, including animal protein sources, principally muscle meat, including fish, viscera and connective tissue, but also other animal proteinaceous material such as feathers.

Pet foods are commonly divided into three categories according to their moisture content; pet foods containing less than about 12% water by weight are generally termed “dry”, those containing between about 12% to about 35% water by weight are generally termed “semi-moist” and those containing between about 35% to about 85% water by weight are generally termed “wet”. Raw meat contains between about 65% to about 75% water and between about 10% and about 20% protein by weight. The high water content of raw meat limits the quantity which can be incorporated into pet foods whilst maintaining an acceptable overall water content for the product. Conventionally, in order to incorporate higher levels of animal protein into pet foods and other foodstuffs, meat meals are employed as a protein source. Meat meals commonly contain between about 3% to about 9% water and between about 55% and about 75% protein by weight. The lower water content of meat meals compared to raw meat enables greater quantities of protein to be incorporated into the pet food by inclusion of meat meals without increasing the water content of the pet food beyond an acceptable level. Conventionally, meat meals are produced by rendering raw meat (heating in superheated steam to temperatures of between about 105° C. and about 140° C.), then pressing the rendered material to squeeze out water and fat. The dried and defatted product is then ground to form a powder which may be incorporated into a foodstuff.

The severe conditions employed in the rendering process used to produce meat meals result in the meat protein in the meals being denatured to an extent during rendering, making the protein less available for digestion by the animal consuming the foodstuff into which the meal is incorporated. The high temperatures used during rendering result in the loss or degradation of heat labile and/or volatile components from the meat, such as vitamins. In addition, water soluble nutrients, such as vitamin C, and fat soluble nutrients, such as vitamins A, D and E, are lost from the meat in the water and fat which is pressed out after rendering. In order to achieve an acceptable nutritional profile for the final product, it is often desirable to reintroduce a number of the nutritional components lost from the meat during manufacture of the meat meal to the foodstuff through the addition of supplements, which increases production costs. As well as being nutritionally undesirable, the loss or degradation of heat labile and/or volatile components from the meat during rendering, and the loss of water and fat soluble nutrients from the meat when pressed after rendering, can result in significant variations in the nutritional profiles of the meat meals produced. As previously discussed, raw meat is also defatted during rendering. Consequently, to improve both the palatability and nutritional profile of foodstuffs incorporating meat meals it may also be desirable to reintroduce fat, commonly through the addition of poultry fat, beef tallow or vegetable oil, such as sunflower oil or soya oil, which again leads to increased production costs. The apparatus employed to produce meat meal imposes limitations on the mix of starting materials which may be utilized to produce meat meals; a minimum proportion of hard and/or fibrous animal material, such as bone, must be included in the mix in order to enable water and fat to be pressed out of the meat after rendering.

It is desirable to be able to tailor the nutritional profile of a foodstuff predictably and reliably through variation of the starting ingredients. The apparatus-imposed restriction on the mix of starting materials which may be employed to produce meat meals, together with the inconsistencies introduced into the nutritional profiles of meat meals by the losses of heat labile and/or volatile components and water and fat soluble nutrients from the meat during production of meat meals, impair this ability.

### BRIEF SUMMARY OF THE INVENTION

According to the present invention there is provided a method of providing a concentrated animal protein product for use as a protein source in foodstuffs, comprising hydrolyzing the animal protein to form a slurry and removing water from the slurry. The animal protein is preferably meat but may be other proteinaceous animal material. The concentrated animal protein product can be made from a wide range of mixes of starting materials, including mixes of starting materials unsuitable for the manufacture of conventional meat meals. The invention also encompasses the concentrated animal protein product provided by the method.

Also according to the invention there is provided a foodstuff, such as a pet food, incorporating a concentrated animal protein product according to the invention.

Also according to the invention there is provided a method of controlling the nutritional content of a foodstuff comprising: selecting a desired level of each of a plurality of components of the food stuff; providing a concentrated animal protein product by a method of the invention having levels of the said components such that when the said product is incorporated in the foodstuff the said components are in the foodstuff at the desired level of each component in the foodstuff; and incorporating the said product in the foodstuff.

### DETAILED DESCRIPTION OF THE INVENTION

The concentrated animal protein product of the invention enables the production of foodstuffs with high animal protein content, adequate fat levels and improved nutritional performance, in terms of nutritional profile and digestibility/bioavailability, compared with foodstuffs relying on conventional meat meals as a protein source. By selection of appropriate animal protein starting materials, the need for the addition of vitamin, fat, oil or other nutritional supplements in order to produce satisfactory foodstuffs can be reduced or eliminated. Additionally, the concentrated animal protein product of the invention enables manufacture of foodstuffs with predictable and reliable targeted nutritional delivery through the selection of animal protein starting materials.

Preferably, the animal protein is raw meat, which may be fish, preferably pre-ground.

Preferably, the hydrolysis of the animal protein is enzymatic hydrolysis, more preferably autolysis, but may also be acid or alkali hydrolysis.

Known water removal techniques may be employed to concentrate the meat slurry, such as osmosis, forced circulation evaporation, ultrafiltration, vacuum drying, freeze drying or oven drying, provided that the technique employed does not detrimentally alter the nutritional profile of the concentrated animal protein product. The invention is, therefore, in no way limited to a concentrated animal protein product produced using any particular water removal technique. Preferably, the removal of water from the slurry is effected by falling film vacuum evaporation or centrifugation or turbo drying.

Prior to concentration of the slurry, an antioxidant may be added to the slurry. Preferably, the antioxidant is added in the form of a solution in a carrier such as soya oil.

Preferably, the concentrated animal protein product contains at least about 20% water by weight. More preferably, the concentrated animal protein product contains between about 40% and about 60% water by weight. Most preferably, the concentrated animal protein product contains between about 45% and about 55% water by weight.

In one embodiment of the invention, pre-ground raw meat is autolysed to produce a meat slurry which is then concentrated by removal of water by falling film vacuum evaporation. After the removal of water by falling film vacuum evaporation, the concentrated animal protein product may be partially defatted by centrifugation.

In an alternative embodiment of the invention, pre-ground raw meat is autolysed to produce a meat slurry which is then concentrated by removal of water and some oil by centrifugation.

According to the invention, it is possible to produce a concentrated animal protein product with high levels of any nutritional component occurring naturally in a proteinaceous animal material by appropriate selection of the animal protein starting materials, and thereby to tailor the nutritional profiles of foodstuffs incorporating concentrated animal protein products according to the invention to very specific diets. For example, according to invention it is possible to produce a concentrated animal protein product with high levels of chondroitin, to promote joint health, by selection of animal protein starting materials rich in trachea, or to produce a concentrated animal protein product with high levels of Omega-3 fatty acids, by selection of animal protein starting materials rich in fish.

The level of incorporation of concentrated animal protein products according to the invention in extruded kibbles, and other foodstuffs, while maintaining an acceptable water content for the final foodstuff may be increased by further reduction in the water content and/or reduction in the fat content of the concentrated animal protein product and/or by combining incorporation of the concentrated animal protein product into the foodstuff by co-extrusion with incorporation by post-extrusion impregnation.

In addition, a reduction in the fat content of the concentrated animal protein product according to the invention improves the expansion properties of foodstuffs co-extruded with the concentrated animal protein product; an extrusion expanded kibble has been successfully made when a fat contribution of as much as 5% by weight of kibble is made by the concentrated animal protein product. Fat may be removed from the concentrated animal protein product in a number of ways, such as by centrifugation or the use of membranes, or may be removed from the slurry prior to concentration, for example by the addition of chemicals. If desired, the removed fat can be reintroduced into the foodstuff after it has been extruded, for example by coating or by impregnation using a vacuum coater.

Prior to concentration of the slurry, ingredients such as salts can be added to the slurry to facilitate the removal of water, for example by effecting pH and/or ionic changes.

The concentrated animal protein product of the invention can be incorporated into extruded dry and semi-moist pet foods and into extruded manufactured chunks by inclusion into the pre-conditioner, co-extrusion by introduction with other ingredients to the barrel of the extruder, or by coating or impregnation of an extruded product subsequent to extrusion, or by any combination of these methods. Alternatively, the concentrated animal protein product of the invention can be incorporated into non-extruded dry and semi-moist pet foods and also manufactured chunks by inclusion into a mixer with other ingredients to produce a cereal dough or meat emulsion which can then be formed, heat set and dried.

The concentrated animal protein product of the present invention can be incorporated into wet pet foods by inclusion in the background meat mix, inclusion in a reformed meat ingredient, inclusion in manufactured chunks, inclusion in the gravy, or by any combination of these methods.

The invention will be understood in greater detail from the following examples of specific embodiments thereof:

### EXAMPLE 1

A concentrated animal protein product is made as follows:

A slurry is formed by autolysis of a pre-ground raw poultry mix; a conventional mixture of poultry heads, feet and viscera. The slurry is then concentrated to a water content of about 53% by weight by falling film vacuum evaporation. The nutritional profile of the concentrated animal protein product obtained is shown in Table 1, along with that of the raw poultry mix from which it was produced and the average nutritional profile of conventional poultry meals; the figures given in each column of Table 1 are the average of the values obtained from analyses of a number, n, of different samples. The figures shown in brackets for Example 1 are the values of the components in the concentrated animal protein product according to the invention on an equal protein basis with the conventional poultry meal.

### EXAMPLE 2

An alternate concentrated animal protein product is made as follows:

A slurry is formed by autolysis of a pre-ground raw poultry mix containing 68% by weight of poultry liver and 29% by weight of the same poultry mix used in Example 1. The slurry is then concentrated to a water content of 60% by weight in the same way as in Example 1. The nutritional profile of the concentrated animal protein product obtained is shown in Table 1.

In Examples 1 and 2, 5.7% by weight of an antioxidant/soya oil solution was added to the slurry prior to concentration.

Little variation was found between the analyzed nutritional profiles of the different samples of the concentrated animal protein product of Example 1, illustrating the consistent nutritional profiles of concentrated animal protein products provided according to the invention. In contrast, in the poultry meal samples analyzed the levels of all vitamins as well as tryptophan, cystine, methionine, taurine and lineolic acid were found to be highly variable.

The in vitro pepsic digestibility, measured using the EC standard method, which gives an indication of the availability of the meat protein for digestion by an animal, of the concentrated animal protein products of Examples 1 and 2 are significantly higher than that of the conventional poultry meal; as previously discussed, the reduced digestibility of the protein in the meal is due to partial denaturing of the protein during the rendering process used to manufacture the meal.

TABLE 1

| | Raw | | | Poultry |
|---|---|---|---|---|
| | Poultry Mix | Example 1 | Example 2 | Meal |
| Raw Materials | n = 3 | n = 5 | n = 1 | n = 11 |
| Proximates | | | | |
| % Moisture | 67.7 | 53.1 | 60.0 | 4.7 |
| % Protein | 14.0 | 16.9 | 21.3 | 66.2 |
| % Fat | 13.4 | 22.8 | 12.2 | 12.5 |
| % Ash | 2.3 | 4.8 | 3.2 | 14.6 |
| % CHO (by | 2.6 | 2.4 | 3.3 | 2.0 |
| difference) | | | | |
| | (n = 3) | (n = 3) | (n = 1) | (n = 9) |
| Dry Matter | | | | |
| Folic Acid (mg/kg) | 1.45 | 1.2 (2.3) | 8.4 (11.1) | 1.96 |
| Vit. B₁₂ | 0.30 | 0.26 (0.50) | 0.33 (0.44) | 0.16 |
| Choline (mg/kg) | | 2.81 (5.41) | 4.9 | 2.3 |
| Biotin (mg/kg) | | 0.28 (0.54) | 4.7 | 0.25 |
| % in Protein | | | | |
| % Tryptophan | 1.1 | 1.0 | — | 0.47 |
| % Histidine | 2.0 | 2.1 | 2.5 | 2.0 |
| % Arginine | 6.1 | 6.4 | 6.3 | 7.9 |
| % Threonine | 3.7 | 3.8 | 4.1 | 3.5 |
| % Alanine | 6.7 | 6.2 | 5.8 | 6.2 |
| % Cystine | 1.1 | 1.1 | 1.3 | 1.2 |
| % Tyrosine | 2.9 | 3.2 | 3.8 | 2.8 |
| % Valine | 4.9 | 4.8 | 5.4 | 4.5 |
| % Methionine | 1.8 | 1.7 | 2.0 | 0.25 |
| % Lysine | 5.8 | 5.9 | 6.9 | 5.5 |
| % Isoleucine | 3.6 | 3.6 | 4.2 | 3.7 |
| % Leucine | 6.6 | 6.8 | 7.9 | 6.5 |
| % Phenylalanine | 3.9 | 4.0 | 4.5 | 3.7 |
| % Taurine | 0.8 | 0.77 | 0.61 | 0.21 |
| % Pepsic Dig. | 89.3 | 90.6 | 92.0 | 84.9 |
| Per kg Fat | | | | |
| Vit. A(IU) | <15.444 | 26.383 | 390.164 | 76.982 |
| | −36.200 | | | |
| Vit D₃ (IU) | — | — | — | 2335 |
| Vit. E (IU) | 30.1 | 36.3 | 154.0 | 58.0 |
| % in Fat | | | | |
| Linoleic | 21.0 | 29.2 | 24.3 | 15.3 |
| Linolenic | 2.0 | 3.5 | 2.3 | 1.8 |
| Arachidonic | 0.67 | 0.67 | 3.4 | 0.73 |

Inclusion of 68% poultry liver in the animal protein starting mixture in Example 2, significantly increases the protein to fat ratio in the concentrated animal protein product obtained and also increases the levels of all vitamins except B12. This illustrates that the nutritional profile of the concentrated animal protein product of the invention can be tailored by selection of the animal protein starting materials.

### EXAMPLE 3

An extruded kibble containing the concentrated animal protein product of Example 1 was made by co-extrusion of the kibble with between about 30% to about 40% by weight of the concentrated animal protein product. The nutritional profile, on a dry matter basis, of the extruded kibble obtained is shown in Table 2, along with that of a “control” kibble co-extruded with between about 9 to about 17% by weight poultry meal; poultry fat was added to the control kibble recipe to give a kibble fat content comparable to that of the kibble of Example 3. The basic kibble recipe employed for the control kibble and Examples 3 to 5 contained equal proportions of maize, wheat and rice flours and no mineral or vitamin supplements.

TABLE 2

| | | | | |
|---|---|---|---|---|
| | +9.0 − 16.5% | | | |
| | Poultry Meal | Example 3 | Example 4 | Example 5 |
| Extruded Kibbles | (n = 8) | (n = 6) | (n = 5) | (n = 1) |

| | | | | |
|---|---|---|---|---|
| Dry Matter | | | | |
| % Protein | 22.1 | 17.0 | 17.0 | 23.4 |
| % Fat | 11.5 | 13.9 | 12.4 | 9.0 |
| % Ash | 3.5 | 3.7 | 3.3 | 2.6 |
| % Ca | 0.67 | 0.43 | 0.41 | 0.19 |
| % P | 0.62 | 0.45 | 0.41 | 0.45 |
| % Mg | 0.09 | 0.085 | 0.08 | 0.08 |
| Mn (mg/kg) | 15.6 | 17.0 | 16.4 | 15.9 |
| % K | 0.33 | 0.40 | 0.34 | 0.38 |
| % Na | 0.14 | 0.58 | 0.51 | 0.35 |
| Fe (mg/kg) | 76.3 | 67.8 | 55.6 | 87.0 |
| Cu (mg/kg) | 6.0 | 10.4 | 6.7 | 5.7 |
| Zn (mg/kg) | 53.4 | 40.7 | 34.0 | 41.8 |
| I (mg/kg) | 4.9 | 3.7 | 4.4 | — |
| Vit B₁ (mg/kg) | 6.1 | 10.9 | 42.3 | 3.5 |
| Vit B₂ (mg/kg) | 5.9 | 9.8 | 23.4 | 10.4 |
| Pantothenic | 13.8 | 19.0 | 20.9 | 37.8 |
| Acid (mg/kg) | | | | |
| Niacin (mg/kg) | 24.0 | 38.5 | 33.8 | 63.5 |
| Vit B₆ (mg/kg) | 2.2 | 2.8 | 3.3 | 2.6 |
| Folic Acid | 1.1 | 1.6 | 1.3 | 3.0 |
| (mg/kg) | — | — | — | — |
| Vit. B₁₂ (mg/kg) | 0.058 | 0.11 | 0.13 | 0.11 |
| Choline (mg/g) | 1.1 | — | — | 1.70 |
| Biotin (mg/kg) | 0.3 | — | — | 0.75 |
| % in Protein | | | | |
| % Tryptophan | 1.0 | 0.97 | 0.95 | 1.25 |
| % Histidine | 2.4 | 2.3 | 2.4 | 2.70 |
| % Arginine | 6.5 | 6.4 | 6.3 | 7.3 |
| % Threonine | 3.5 | 3.4 | 3.4 | 3.7 |
| % Alanine | 5.4 | 5.6 | 5.4 | 4.8 |
| % Cystine | 0.68 | 0.82 | 0.77 | 0.60 |
| % Tyrosine | 3.3 | 3.3 | 3.3 | 3.8 |
| % Valine | 4.6 | 4.7 | 4.7 | 4.7 |
| % Methionine | 0.8 | 0.76 | 0.63 | 0.46 |
| % Lysine | 4.5 | 4.3 | 4.0 | 4.0 |
| % Isoleucine | 3.8 | 3.7 | 3.6 | 3.7 |
| % Leucine | 8.0 | 8.2 | 8.2 | 7.8 |
| % Phenylalanine | 4.5 | 4.5 | 4.5 | 5.3 |
| % Taurine | 0.28 | 0.48 | 0.54 | 0.33 |
| Per kg Fat | | | | |
| Vit. A (IU) | 161.858 | 37.142 | 28.265 | 738.554 |
| Vit. D₃ (IU) | — | 1180 | — | — |
| Vit. E (IU | 447 | 495 | 209 | 106 |
| % in Fat | | | | |
| Linoleic | 29.4 | 28.4 | 28.4 | 27.8 |
| Linolenic | 3.0 | 3.4 | 3.4 | 2.1 |
| Arachidonic | 0.33 | 0.41 | 0.41 | 2.0 |

### EXAMPLE 4

An extruded kibble containing the concentrated animal protein product of Example 1 was made by sequential impregnation of the extruded kibble with the concentrated animal protein product using a vacuum coater. The as-extruded kibble, with a moisture content of about 20% water by weight, was first impregnated with about 20% by weight of the concentrated animal protein product, then dried to a moisture content of about 20% water by weight, before a second impregnation with about 12% by weight of the concentrated animal protein product. The nutritional profile of the extruded kibble obtained is shown in Table 2.

### EXAMPLE 5

An extruded kibble containing the concentrated animal protein product of Example 2 was made by co-extrusion of the kibble with about 40% by weight of the concentrated animal protein product. The nutritional profile of the extruded kibble obtained is shown in Table 2.

As can be seen in Table 2, up to about 40% of the concentrated animal protein products of Examples 1 and 2 can be satisfactorily incorporated into the extruded kibbles, either by co-extrusion or by sequential, post-extrusion, impregnation using a vacuum coater.

Extruded kibbles produced by co-extrusion with the concentrated animal protein product of Example 2, produced from a raw mix containing a high proportion of poultry liver, have increased protein to fat ratios and also significantly increased levels of most vitamins. This illustrates that the nutritional profile of a foodstuff into which a concentrated animal protein product according to the invention is incorporated can be successfully tailored by selection of the animal protein starting materials from which the concentrated animal protein product is produced. It will be appreciated that the tailoring of the nutritional profile of a foodstuff by incorporation of a concentrated animal protein product according to the invention is not limited to variation of the content in the foodstuff of those nutrients listed in Tables 1 and 2.

The effect of water removal, and water and fat removal, on the water, protein and fat contents of the concentrated animal protein products of Examples 1 and 2 is shown in Table 3, along with the water, protein and fat contents of extruded kibbles co-extruded with the concentrated animal protein products.

TABLE 3

| | ROM | | | | Contribution | | | Poultry Meal |
|---|---|---|---|---|---|---|---|---|
| | Analysis (%) | | | Co-Extruded | to Extrudate (%) | | | Equivalent (%) |
| Raw Material | H₂0 | Protein | Fat | Level (%) | H₂0 | Protein | Fat | (Equal Protein) |
| Poultry Meal | 4.7 | 66.2 | 12.5 | 10.0 | — | 6.6 | 1.25 | 10.0 |
| | | | | 20.0 | — | 13.2 | 2.50 | 20.0 |
| | | | | 30.0 | — | 19.9 | 3.75 | 30.0 |
| Example 1 | 56.2 | 18.7 | 18.1 | 40.0 | 22.6 | 7.5 | 7.2 | 11.3 |
| Example 1: 45% water | 45.0 | 23.5 | 22.7 | 50.0 | 22.5 | 11.8 | 11.4 | 17.8 |
| Example 1: 45% water; fat content | 50.8 | 26.5 | 12.8 | 44.5 | 22.6 | 11.8 | 5.7 | 17.8 |
| reduced by 50% | | | | | | | | |
| Example 1: 45% water; fat content | 54.2 | 28.3 | 6.9 | 41.5 | 22.5 | 11.7 | 2.9 | 17.7 |
| reduced by 75% | | | | | | | | |
| Example 2 | 60.0 | 21.3 | 12.2 | 40.0 | 24.0 | 8.5 | 4.9 | 12.8 |
| Example 2: 50% water | 50.0 | 26.6 | 15.3 | 48.0 | 24.0 | 12.8 | 7.3 | 19.3 |
| Example 2: 50% water; fat content | 54.1 | 28.8 | 8.3 | 44.4 | 24.0 | 12.8 | 3.7 | 19.3 |
| reduced by 50% | | | | | | | | |

The concentrated animal protein product of the invention has been found to have an improved nutritional performance compared to conventional meat meals. The concentrated animal protein product of the invention can be manufactured using a wide range of mixes of raw meat and other animal protein starting materials, including mixes unsuitable for the manufacture of conventional meat meals. Use of the concentrated animal protein product of the invention as a protein source enables the manufacture of foodstuffs with high protein content, acceptable fat levels and predictable and reliable targeted nutritional profiles. By selection of appropriate animal protein starting materials, use of the concentrated animal protein product of the invention as a protein source, reduces or eliminates the need for the addition of vitamin, fat, oil or other nutritional supplements in order to produce satisfactory foodstuffs.

What is claimed is:

1. A method of providing a concentrated animal protein product for use as a protein source in foodstuffs, comprising hydrolyzing the animal protein to form a slurry and removing water from the slurry.

2. A method according to claim 1 wherein the animal protein is raw meat.

3. A method according to claim 2 wherein the meat is pre-ground.

4. A method according to claim 1, 2 or 3 wherein the hydrolysis is enzymatic hydrolysis.

5. A method according to any preceding claim wherein the hydrolysis is autolysis.

6. A method according to any preceding claim further comprising effecting chemical changes to facilitate the removal of water and/or fat from the slurry.

7. A method according to any preceding claim further comprising addition of an antioxidant to the slurry prior to water removal.

8. A method according to any preceding claim wherein the water is removed by turbo drying or falling film vacuum evaporation.

9. A method according to any preceding claim further comprising the removal of fat from the concentrated animal protein product prior to inclusion of the product in a foodstuff.

10. A method according to claim 9 further comprising the subsequent addition of fat to the foodstuff.

11. A concentrated animal protein product produced by a method according to any of claims 1 to 10.

12. A concentrated animal protein product according to claim 11 containing at least 20% water by weight.

13. A concentrated animal protein product according to claim 11 or 12 containing between 40% and 60% water by weight.

14. A concentrated animal protein product according to claim 11, 12 or 13 containing between 45% and 55% water by weight.

15. A concentrated animal protein product characterized in that it contains between 45% and 55% water by weight.

16. A foodstuff incorporating a concentrated animal protein product according to any of claims 11 to 15.

17. A pet foodstuff according to claim 16.

18. A method of controlling the nutritional content of a foodstuff comprising:
selecting a desired level of each of a plurality of components of the food stuff;
providing a concentrated animal protein product by a method according to any of claims 1 to 9 having levels of the said components such that when the said product is incorporated in the foodstuff the said components are in the foodstuff at the desired level of each component in the foodstuff; and
incorporating the said product in the foodstuff.

19. A method for producing a concentrated animal protein product substantially as described.

20. A concentrated animal protein product substantially as described.
